(19) United States
(12) Patent Application Publication
(10) Pub. No.: US 2011/0069115 A1
(43) Pub. Date: Mar. 24, 2011

(54) IMAGE FORMING APPARATUS

(75) Inventors: Hiroyuki Tanabe, Kanagawa (JP); Hiroyuki Igarashi, Kanagawa (JP)

(73) Assignee: FUJI XEROX CO., LTD., Tokyo (JP)

(21) Appl. No.: 12/713,212

(22) Filed: Feb. 26, 2010

(30) Foreign Application Priority Data
Sep. 18, 2009 (JP) 2009-217377

(51) Int. Cl. B41J 2/165

(52) U.S. Cl. 347/34

(57) ABSTRACT

An image forming apparatus of an aspect of the present invention includes: a transport body that rotates while retaining a recording medium on an outer surface thereof; a liquid droplet ejection head that ejects liquid droplets onto the recording medium retained on the transport body; a collection unit, provided at a downstream side in a rotation direction of the transport body with respect to the liquid droplet ejection head and provided with a suction inlet through which a mist of the liquid droplets is sucked, that collects the mist sucked in from the suction inlet; and a guide member, provided between the suction inlet and the liquid droplet ejection head, that guides the mist toward the suction inlet.

### CROSS-REFERENCE TO RELATED APPLICATION

This application is based on and claims priority under 35 USC 119 from Japanese Patent Application No. 2009-217377 filed Sep. 18, 2009.

### BACKGROUND

1. Technical Field

The present invention relates to an image forming apparatus.

2. Summary

An image forming apparatus of an aspect of the present invention includes: a transport body that rotates while retaining a recording medium on an outer surface thereof; a liquid droplet ejection head that ejects liquid droplets onto the recording medium retained on the transport body; a collection unit, provided at a downstream side in a rotation direction of the transport body with respect to the liquid droplet ejection head and provided with a suction inlet through which a mist of the liquid droplets is sucked, that collects the mist sucked in from the suction inlet; and a guide member, provided between the suction inlet and the liquid droplet ejection head, that guides the mist toward the suction inlet.

### BRIEF DESCRIPTION OF THE DRAWINGS

Exemplary embodiment of the present invention will be described in detail based on the following figures, wherein:

FIG. 1 is an enlarged cross-section showing a collection device and a guide member employed in an image forming apparatus according to an exemplary embodiment of the present invention;

FIG. 2 is a cross-section showing a collection device and a guide member employed in an image forming apparatus according to an exemplary embodiment of the present invention;

FIG. 3 is a perspective view showing a collection device and a guide member employed in an image forming apparatus according to an exemplary embodiment of the present invention;

FIG. 4 is an enlarged perspective view showing a collection device and a guide member employed in an image forming apparatus according to an exemplary embodiment of the present invention;

FIG. 5 is a diagram showing simulation results of air flow in the vicinity of a collection device and a guide member employed in an image forming apparatus according to an exemplary embodiment of the present invention;

FIG. 6 is a schematic configuration diagram showing an image forming apparatus according to an exemplary embodiment of the present invention; and

FIG. 7 is a perspective view showing a support frame, on which liquid droplet ejection heads employed in an image forming apparatus according to an exemplary embodiment of the present invention are supported.

### DETAILED DESCRIPTION

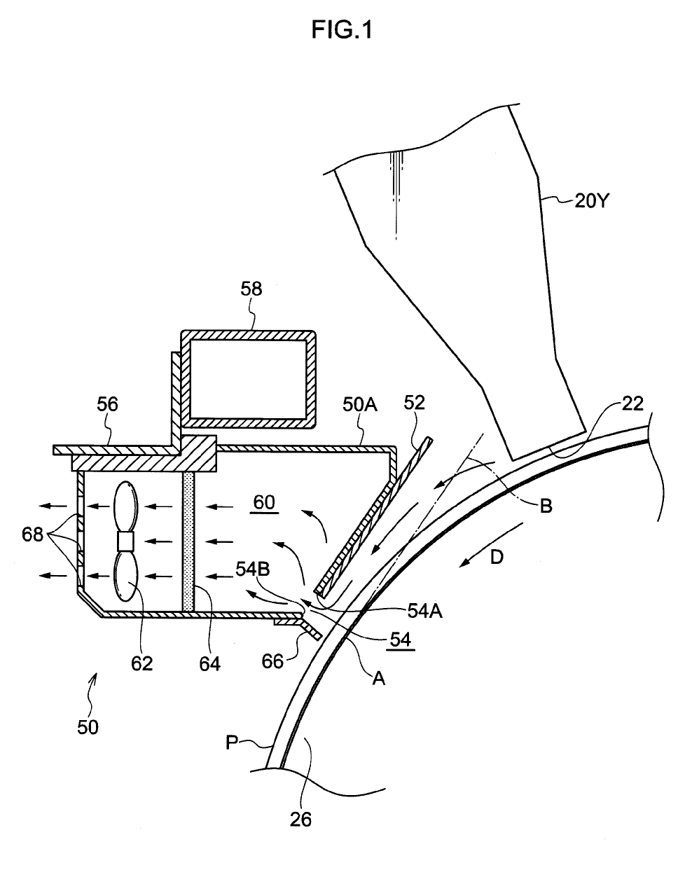

Explanation will now be given of an example of an image forming apparatus according to an exemplary embodiment of the present invention, with reference to FIG. 1 to FIG. 7.

Overall Configuration

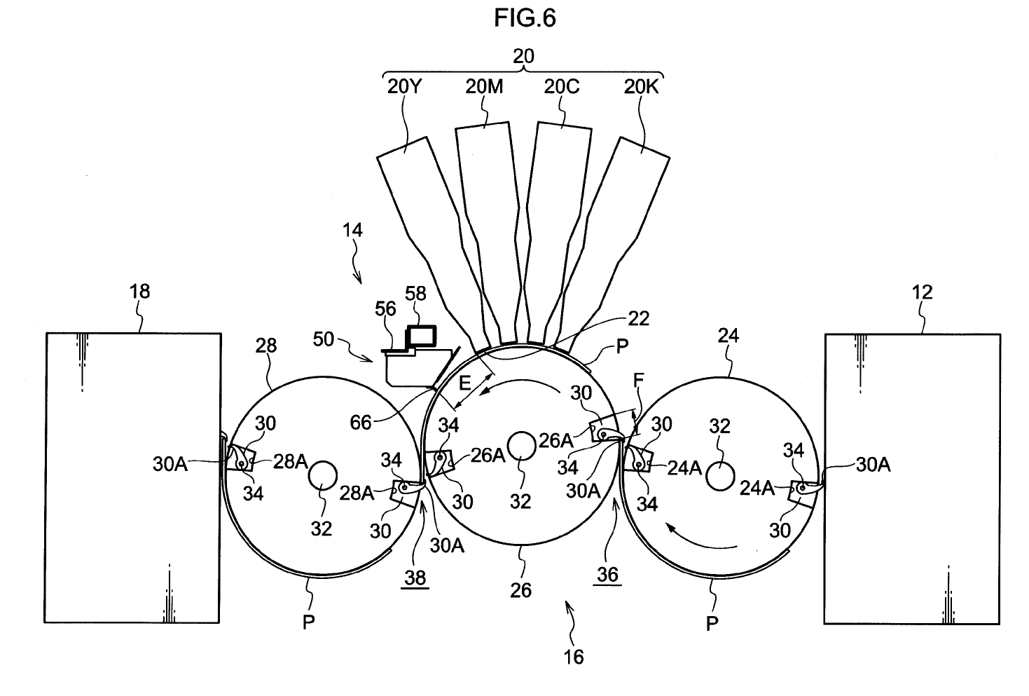

As shown in FIG. 6, an inkjet recording apparatus 10, serving as an image forming apparatus, includes: a paper feed unit 12 in which a sheet member P is accommodated as a recording medium prior to recording with an image; an image recording unit 14 that records an image on the sheet member P fed from the paper feed unit 12; a transfer unit 16 that transfers the sheet member P to the image recording unit 14; and a paper discharge unit 18 that accommodates the sheet member P that is recorded with an image by the image recording unit 14 and transferred by the transfer unit 16.

Transfer Unit

The transfer unit 16 includes: a cylindrical take-up drum 24 that, while rotating, takes out the sheet member P accommodated in the paper feed unit 12 one sheet at a time, and retains the sheet member P on its outer surface; a cylindrical transport drum 26, serving as an example of a transport body, receives the sheet member P from the take-up drum 24 while rotating, and transports the received sheet member P, while retaining the sheet member P on its outer surface, to a position facing the image recording unit 14; and a feed-out drum 28 that, while rotating, receives the sheet member P recorded with an image by the image recording unit 14 from the transport drum 26, and, while retaining the sheet member P on its outer surface, feeds the received sheet member P to the paper discharge unit 18.

More precisely, the outer surfaces of the take-up drum 24, the transport drum 26, and the feed-out drum 28 are configured so as to retain the sheet member P using an electrostatic attraction device, or a non-electrostatic attraction device, such as one using suction, tackiness, or the like.

In each of the outer surfaces of the take-up drum 24, the transport drum 26, and the feed-out drum 28, two concave shaped recess portions 24A, two concave shaped recess portions 26A, two concave shaped recess portions 28A are formed respectively. The two recess portions 24A, 26A, 28A are provided on two respective sides of each rotation shaft 32 for the drums 24, 26, 28, and the recess portions 24A, 26A, 28A extend along the axial direction of the rotation shafts 32. Rotation shafts 34 are provided within the recess portions 24A, 26A, 28A, parallel to the rotation shafts 32 of each of the drums 24, 26, 28.

There are also plural retaining fittings 30 disposed in the respective recess portions 24A, 26A, 28A and disposed at specific intervals along the axial direction of the rotation shafts 34. The retaining fittings 30 are provided, at their leading ends, with retaining portions 30A that protrude out from the outer surface of each of the drums 24, 26, 28, nipping and retaining the leading end of the sheet member P between the outer surface of the drum. The base end portions of these retaining fittings (the end portion at the opposite side to that of the retainer 30A) are fixed to the respective rotation shafts 34.

The rotation shafts 34 are rotated in both forward and reverse directions by non-illustrated actuators, and the retaining fittings 30 rotate in both forward and reverse directions along the circumferential direction of the respective drums 24, 26, 28. The retaining portions 30A of the retaining fittings 30 retain the sheet member P, or remove the sheet member P, by rotation of the retaining fittings 30 in the forward or reverse directions.

In other words, by projecting the retaining portions 30A, provided at the retaining fittings 30, out from the outer surfaces of the respective drums 24, 26, 28 and by rotationally moving the retaining portions 30A, the sheet member P can be handed over from the retaining fittings 30 of the take-up drum 24 to the retaining fittings 30 of the transport drum 26, at a hand-over position 36 where the outer surface of the take-up drum 24 faces the outer surface of the transport drum 26, and further, the sheet member P can also be handed over from the retaining fittings 30 of the transport drum 26 to the retaining fittings 30 of the feed-out drum 28 at a hand-over position 38 where the outer surface of the transport drum 26 faces the outer surface of the feed-out drum 28.

Image Recording Unit

The image recording unit 14 is disposed facing the transport drum 26. Liquid droplet ejection heads 20Y, 20M, 20C, and 20K, that form images on the sheet member P by ejecting liquid droplets, of each of the colors Y (yellow), M (magenta), C (cyan), and K (black), onto the sheet member P retained on the outer surface of the transport drum 26, are disposed along the rotation direction of the transport drum 26, in this sequence from the downstream side.

Note that in the explanation that follows, the capital letter corresponding to each of the colors will be added when the different colors are differentiated, however these capital letters corresponding to the colors will be omitted when there is no particular differentiation made.

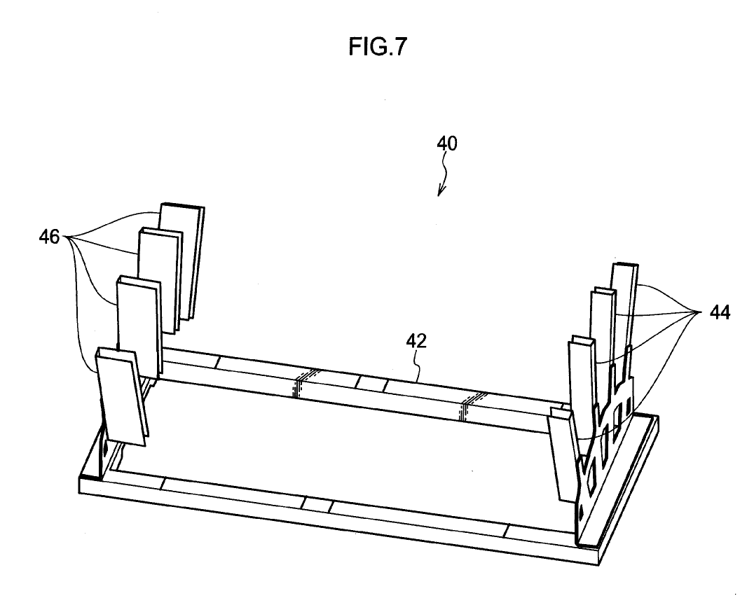

Each liquid droplet ejection head 20 is equipped with nozzle a face 22 formed with nozzles (not shown in the drawings) that eject liquid droplets. A support stand 40, as shown in FIG. 7, is provided facing the transport drum 26, such that the nozzle faces 22 of the liquid droplet ejection heads 20 are supported facing the outer surface of the transport drum 26.

The support stand 40 is provided with a substantially rectangular frame 42, and four pairs of raising and lowering guides 44, 46. The raising and lowering guides 44, 46 are fixed to the frame 42 and are provided in substantially radial manner with respect to the axial line of the transport drum 26, with the two side edge portions of each of the liquid droplet ejection heads 20 fitting into the raising and lowering guides 44, 46.

Furthermore, as shown in FIG. 6, a collection device 50 is provided downstream side of the liquid droplet ejection head 20Y in the transport drum 26 rotation direction. The collection device 50 serves as one example of a collection unit that collects mist of liquid droplets ejected from the liquid droplet ejection heads 20 (liquid droplets ejected from the nozzles that rise up in a mist form).

Configuration of Main Portion

Explanation will now be given of the collection device 50 that collects mist of liquid droplets ejected from the liquid droplet ejection heads 20, and the like.

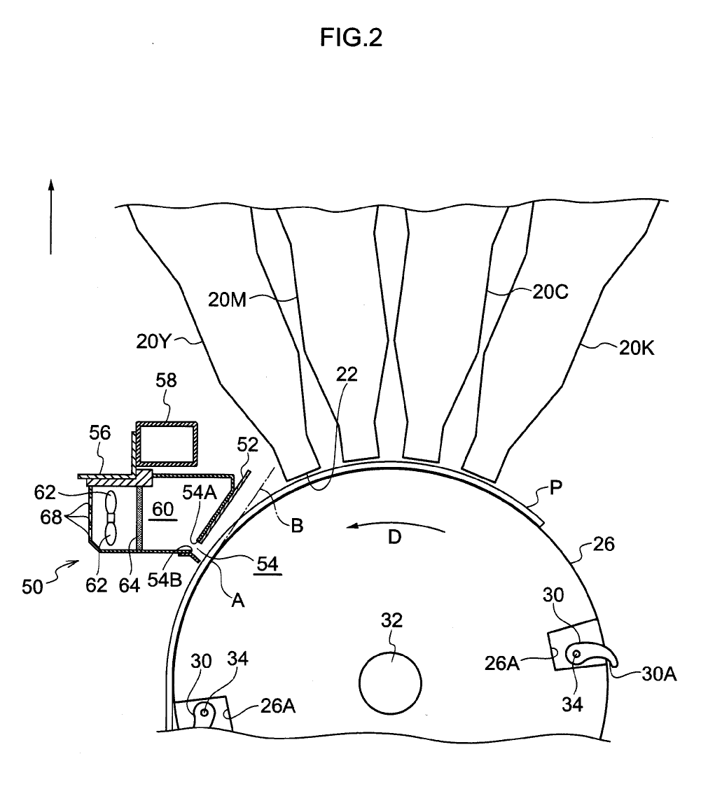

As shown in FIG. 1 and FIG. 2, the collection device 50 is provided with a box shape casing 50A that extends along the axial direction of the rotation shaft 32 of the transport drum 26 (the direction into and out of the paper in the diagrams, referred to below simply as “axial direction”), facing the outer surface of the transport drum 26 across the entire axial direction length thereof. A substantially L-shaped fixing member 56 that extends along the axial direction is fixed to the top face of the collection device 50 (the face that faces upwards in FIG. 2) by a non-illustrated fastener. A frame member 58 that extends in the axial direction and is fixed to the apparatus body is also provided, with the fixing member 56 being fixed to the frame member 58 with a non-illustrated fastener.

An airflow path 60 is formed inside the casing 50A of the collection device 50, through which the collected mist flows. A portion of a wall plate forming the airflow path 60 is open such that a suction inlet 54 is provided extending along the axial direction to suck in mist of liquid droplets. Note that the position of the suction inlet 54 is determined such that the length from the suction inlet 54 to the liquid droplet ejection head 20Y (shown as dimension E in FIG. 6) is longer than the circumferential direction length of the opening of the recess portion 26A (shown as dimension F in FIG. 6).

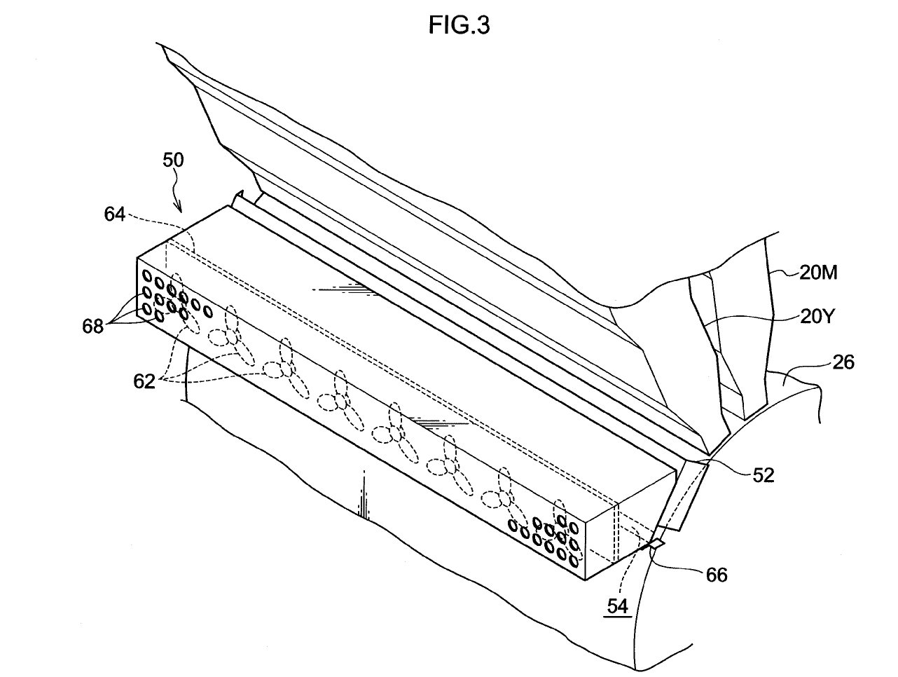

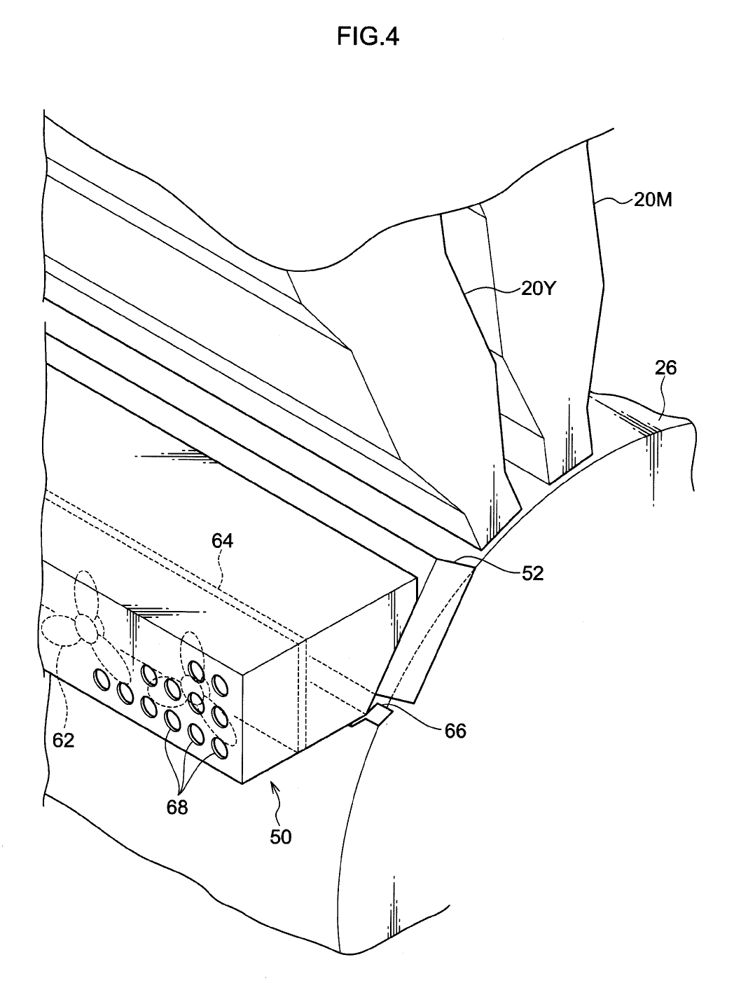

In addition, eight suction fans 62 (see FIG. 3) are provided in a row along the axial direction within the casing 50A of the collection device 50 and serve as an example of suctioning members that impart suction force sucking mist in toward the suction inlet 54. Plural circular discharge outlets 68 (see FIG. 4) are provided at the rear (the left side in FIG. 2) of the suction fans 62. The discharge outlets 68 discharge air that has been sucked into the casing 50A by the suction fans 62 externally (to the outside).

Further, there is a filter 64 provided so as to partition between the suction fan 62 installation space and the airflow path 60. The filter 64 captures mist sucked in from the suction inlet 54 and passed through the airflow path 60.

The shape of the airflow path 60 is determined such that mist sucked in from the suction inlet 54 by the suction force of the suction fans 62 spreads out in the airflow path 60.

A plate-shaped guide member 52 is provided between the suction inlet 54 and the liquid droplet ejection head 20Y to guide the mist of liquid droplets ejected from the liquid droplet ejection heads 20 towards the suction inlet 54. The guide member 52 is fixed to the casing 50A by non-illustrated fastener.

More precisely, the mist flows toward the downstream side in the rotation direction of the transport drum 26, along the outer surface of the transport drum 26 rotating in the direction of arrow D. The guide member 52 is configured such that mist flowing toward the downstream side in the transport drum 26 rotation direction is guided into the suction inlet 54.

In order to suppress leakage of mist outside the guide member 52 from between the liquid droplet ejection head 20Y and the guide member 52, a one end portion of the guide member 52 which is at the liquid droplet ejection head 20Y side extends out to a position that is as close as possible to the liquid droplet ejection head 20Y, while considering the movable range when attaching and detaching the liquid droplet ejection head 20Y to and from the support stand 40.

Furthermore, the guide member 52 is disposed such that the space between the guide member 52 and the outer surface of the transport drum 26 gets narrower when approaching the suction inlet 54, and the other end portion of the guide member 52 contacts an opening edge 54A at the upstream side of the suction inlet 54 in the transport drum 26 rotation direction.

More precisely, when viewed along the axial direction, if the closest point on the outer surface of the transport drum 26 to an opening edge 54B which is at the downstream side of the suction inlet 54 in the transport drum 26 rotation direction is point A, then the guide member 52 is disposed such that a tangent B, contacting the outer surface of the transport drum 26 at the point A, and the guide member 52 are parallel. In the other wards, the distance (the closest (the shortest) distance) between the point A and the opening edge 54B is narrower than the closest (the shortest) distance between the transport drum 26 and the opening edge 54A.

At a portion of the casing 50A configured by the opening edge 54B which is at the downstream side of the suction inlet 54 in the transport drum 26 rotation direction, a projecting plate 66 is provided projecting out toward the rotation shaft 32 of the transport drum 26, along the axial direction. The base end of the projecting plate 66 is fixed to the casing 50A.

Furthermore, as shown in FIG. 3 and FIG. 4, the both axial direction end portions of the projecting plate 66 and the both axial direction end portions of the guide member 52 are preferably bent around toward the transport drum 26, so as to suppress mist from leaking toward the axial direction outsides from the projecting plate 66 and the guide member 52.

Operation

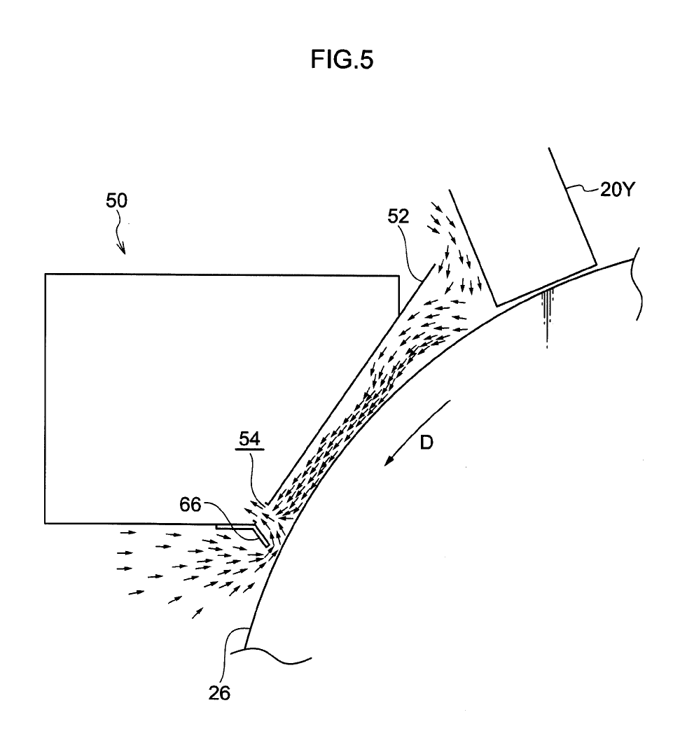

First, explanation will be given regarding the flow of air occurring at the downstream side of the liquid droplet ejection head 20 in the transport drum 26 rotation direction. FIG. 5 shows simulation results of air flow occurring between the liquid droplet ejection head 20, the transport drum 26 and the collection device 50, with the arrow direction representing the direction of flow of air, and the number of arrows representing the air flow rate. In other words, as the arrows become denser, the flow of air is greater with a faster airflow speed, in comparison to where the arrows are sparse (non-dense).

It can be seen from this simulation result that flow speed of the air flowing between the guide member 52 and the transport drum 26 gets faster further approaching the suction inlet 54, since the space between the guide member 52 and the transport drum 26 gets narrower nearer to the suction inlet 54.

Furthermore, it can be seen that air flowing between the guide member 52 and the transport drum 26 hits the projecting plate 66, and is sucked into the suction inlet 54. It can also be seen that the air which is at the transport drum 26 rotation direction downstream side of the projecting plate 66 passes through between the projecting plate 66 and the transport drum 26 by suction force generated at the suction inlet 54, and is sucked into the suction inlet 54.

Consequently, as shown in FIG. 1, the mist of liquid droplets ejected from the liquid droplet ejection heads 20 toward the sheet member P flows along the outer surface of the transport drum 26 rotating in the direction of arrow D, toward the transport drum 26 rotation direction downstream side.

The mist that has flowed to the transport drum 26 rotation direction downstream side is guided toward the suction inlet 54 by the guide member 52. When this occurs, since the space between the guide member 52 and the transport drum 26 gets narrower closer to the suction inlet 54, the flow speed of the mist gets faster closer to the suction inlet 54. Since the flow speed of the mist gets faster closer to the suction inlet 54, the mist more readily separates from the layer of air covering the outer surface of the transport drum 26, in comparison to a case where the flow speed of the mist does not change.

A suction force is generated at the suction inlet 54 by driving the suction fans 62. Due to the suction force generated at the suction inlet 54, the mist guided by the guide member 52 and/or hitting the projecting plate 66 is sucked into the airflow path 60 from the suction inlet 54.

As described above, the shape of the airflow path 60 is determined such that the mist sucked in from the suction inlet 54, by the suction force of the suction fans 62, spreads out in the airflow path 60. Therefore, unevenness in the suction force of the suction inlet 54 extending along the axial direction is suppressed from occurring. Furthermore, by suppressing unevenness of suction force (air speed distribution) generated at the suction inlet 54 extending along the axial direction from occurring, unevenness of air flow rate passing through the filter 64 extending along the axial direction is also suppressed from occurring.

The mist sucked in toward the airflow path 60 is collected by the filter 64, and air, from which the mist has been collected, passes through the suction fans 62 and is discharged from the discharge outlets 68.

By providing the guide member 52 which guides the mist toward the suction inlet 54 in this manner, the mist of liquid droplets ejected from the liquid droplet ejection heads 20 and flowing toward the transport drum 26 downstream side, is collected.

Furthermore, by collecting the mist of liquid droplets flowing toward the transport drum 26 rotation direction downstream side, this suppress mist from floating around in the device and adhering to other components, or adhering to the sheet member P.

Furthermore, as stated above, the space between the guide member 52 and the transport drum 26 is narrower nearer to the suction inlet 54. Therefore, the flow speed of the mist gets faster closer to the suction inlet 54, and the mist is easily separated from the layer of air covering the outer surface of the transport drum 26.

Furthermore, the projecting plate 66 is provided at the opening edge 54B which is at the transport drum 26 rotation direction downstream side of the suction inlet 54, the projecting plate 66 projects toward the rotation shaft 32 of the transport drum 26. Consequently, mist flowing toward the transport drum 26 rotation direction downstream side hits the projecting plate 66, and is sucked into the suction inlet 54.

Furthermore, as can be seen from the simulation results, due to the suction force occurring at the suction inlet 54, the air at the downstream side in the transport drum 26 with respect to the projecting plate 66 is sucked, passing through between the projecting plate 66 and the transport drum 26, into the suction inlet 54. Consequently, mist guided by the guide member 52 and flowing toward the transport drum 26 rotation direction downstream side is suppressed from leaking out to the transport drum 26 rotation direction downstream side from between the projecting plate 66 and the transport drum 26.

The shape of the airflow path 60 is determined such that the mist sucked in from the suction inlet 54 by the suction force of the suction fans 62 spreads out in the airflow path 60. Consequently, unevenness in suction force of the suction inlet 54 extending along the axial direction is suppressed from occurring.

Furthermore, by suppressing the occurrence of unevenness in the suction force of the suction inlet 54 extending along the axial direction, mist is sucked in from the suction inlet 54 uniformly across the axial direction.

Furthermore, by suppressing the occurrence of unevenness in the suction force of the axial direction extending suction inlet 54, unevenness in the flow rate of air passing through the axial direction extending filter 64 is also suppressed from occurring.

Furthermore, by suppressing the occurrence of unevenness in air flow rate passing through the axial direction extending filter 64, mist is adhered across the entire filter 64, therefore prolonging the lifespan of the filter 64.

The length from the suction inlet 54 to the liquid droplet ejection head 20Y (dimension E shown in FIG. 6) is longer than the opening length of the recess portion 24A (dimension F shown in FIG. 6). Consequently, mist floating inside the recess portion 26A is suppressed from leaking out to the transport drum 26 rotation direction downstream side with respect to the projecting plate 66.

Note that while a detailed explanation has been given of the present invention by way of exemplary embodiment, the present invention is not limited to the exemplary embodiment, and a person of ordinary skill in the art will be aware that various other embodiments are possible within the scope of the present invention. For example, in the exemplary embodiment above, the casing 50A, the guide member 52, and the projecting plate 66 are provided as separate members, however at least one of the guide member and the projecting plate may be integrated with the casing. That is, for example, the guide member 52 may be integrated with the casing 50A such that the end portion of the guide member 52 at the downstream side in the rotation direction of the transport drum 26 configures the opening edge 54A of the suction inlet 54 at the upstream side in the rotation direction of the transport drum 26.

Furthermore, in the above exemplary embodiment, the surface of the guide member 52 is formed as a flat surface such that the space between the outer surface of the transport drum 26 and the guide member gets narrower closer to the suction inlet 54, however, for example, the surface of the guide member may be a curved or stepped shape such that the space between the outer surface of the transport drum and the guide member gets narrower closer to the suction inlet.

What is claimed is:

1. An image forming apparatus comprising:
a transport body that rotates while retaining a recording medium on an outer surface thereof;
a liquid droplet ejection head that ejects liquid droplets onto the recording medium retained on the transport body;
a collection unit, provided at a downstream side in a rotation direction of the transport body with respect to the liquid droplet ejection head and provided with a suction inlet through which a mist of the liquid droplets is sucked, that collects the mist sucked in from the suction inlet; and
a guide member, provided between the suction inlet and the liquid droplet ejection head, that guides the mist toward the suction inlet.

2. The image forming apparatus of claim 1, wherein the guide member is disposed such that distance between the guide member and the transport body decreases closer to the suction inlet.

3. The image forming apparatus of claim 1, wherein an end portion of the guide member at the downstream side in the rotation direction of the transport body makes contact with an opening edge of the suction inlet at an upstream side in the rotation direction of the transport body.

4. The image forming apparatus of claim 3, wherein a smallest distance between the transport body and the opening edge of the suction inlet at the downstream side in the rotation direction of the transport body is shorter than a smallest distance between the transport body and the opening edge of the suction inlet at the upstream side in the rotation direction of the transport body.

5. The image forming apparatus of claim 1, wherein a projecting plate that projects out toward the transport body is provided at an opening edge of the suction inlet at the downstream side in the rotation direction of the transport body.

6. The image forming apparatus of claim 1, wherein the collection unit includes:
an airflow path at which the suction inlet is formed, and
a suctioning member that imparts suction force sucking in the mist from the suction inlet toward the airflow path,
wherein a shape of the airflow path is determined such that the mist sucked in from the suction inlet by the suction force of the suctioning member spreads out in the airflow path.

7. The image forming apparatus of claim 6, wherein a capture member that captures the mist is provided in the collection unit between the airflow path and the suctioning member.

8. The image forming apparatus of claim 1, wherein an end portion of the guide member at the downstream side in the rotation direction of the transport body forms an opening edge of the suction inlet at an upstream side in the rotation direction of the transport body.

9. The image forming apparatus of claim 1, wherein a recessed portion in which a retaining member is provided is formed at the transport body, the retaining member retaining the recording medium between the retaining member and the outer surface of the transport body,
wherein a distance between the liquid droplet ejection head and the suction inlet is longer than a length of the recessed portion in the rotation direction of the transport body.

10. An image forming apparatus comprising:
a transport body that rotates while retaining a recording medium on an outer surface thereof;
a liquid droplet ejection head that ejects liquid droplets onto the recording medium retained on the transport body;
a collection unit, provided at a downstream side in a rotation direction of the transport body with respect to the liquid droplet ejection head and provided with a suction inlet through which a mist of the liquid droplets is sucked, that collects the mist sucked in from the suction inlet;
a guide member, provided between the suction inlet and the liquid droplet ejection head, that guides the mist toward the suction inlet; and
a projecting plate, provided at an opening edge of the suction inlet at the downstream side in the rotation direction of the transport body, that projects out toward the transport body.

11. The image forming apparatus of claim 10, wherein the guide member is disposed such that distance between the guide member and the transport body decreases closer to the suction inlet.
